(19) United States
(12) Patent Application Publication
(10) Pub. No.: US 2024/0360305 A1
(43) Pub. Date: Oct. 31, 2024

(54) ARTICLES OF MANUFACTURE PRODUCED FROM HIGHLY THERMOFORMABLE ACRYLIC SOLID SURFACE WITH MATTE SURFACE

(71) Applicant: Trinseo Europe GmbH, Horgen (CH)

(72) Inventors: Ronald Lun, Florence, KY (US); Neil Caldwell, Erlanger, KY (US); Mark Gatman, Erlanger, KY (US); Sebastian Joseph, Mason, OH (US)

(21) Appl. No.: 18/687,899

(22) PCT Filed: Sep. 1, 2022
(86) PCT No.: PCT/US2022/075808

§ 371 Date: Feb. 29, 2024

Related U.S. Application Data
(60) Provisional application No. 63/239,451, filed on Sep. 1, 2021.

(51) Int. Cl. C08L 33/08; C08F 220/14; C08F 220/18; C08J 5/18; C08K 3/22

(52) U.S. Cl. CPC C08L 33/08; C08F 220/14; C08F 220/1804; C08J 5/18; C08K 3/22; C08J 2333/08; C08K 2003/2227; C08K 2201/005; C08L 2203/16; C08L 2203/30

(57) ABSTRACT

A thermoformable acrylic article includes a basin portion, a deck at least partially surrounding the basin portion, wherein the thermoformable article is made of a thermoformable composition including: a) about 35-95 wt % an acrylic pre-polymerized syrup; b) about 0-10 wt % of a comonomer; and c) about 5-65 wt % of a filler, wherein the filler has an average particle size (d50) in a range of 0.1 μm to 50 μm, and, wherein the surface of the thermoformable article has a matte finished.

### RELATED APPLICATION

This application claims priority to U.S. Provisional Application No. 63/239,451, filed Sep. 1, 2021, entitled “ARTICLES OF MANUFACTURE PRODUCED FROM HIGHLY THERMOFORMABLE ACRYLIC SOLID SURFACE WITH MATTE SURFACE,” the subject matter of which is incorporated herein by reference in its entirety.

### BACKGROUND

Thermoformable acrylics or other plastic materials are utilized in the marketplace to produce glossy surfaces for use in wet areas, such as pools, kitchens, and baths. For a long time acrylic was a dominant material used in wet areas for architectural, transportation, and wellness industries. However, the market has changed with a preference towards surfaces with satin and matte finishes. This has led to an increase in the use of more expensive solid surface material to achieve the desired aesthetic.

In order to achieve a similar aesthetic to that of solid surface products, thermoformed acrylic materials require additional treatment post-thermoforming to remove inherent gloss or gloss acquired during the thermoforming process. This holds true for cell cast, pre-textured acrylic sheeting, where to achieve a matte surface finish the final surface is mechanically modified to a matte finish. Current thermoforming methods of preparing polymeric surfaces having a matte appearance and textured finish often employ mechanical methods of surface roughening, such as during a casting or extrusion process on a liquid or molten acrylic to produce a textured sheet, or by sanding or abrasion. Mechanical methods are often limited in end-use applications, however, as downstream processing of the polymeric surfaces by stretching or heating to form more complex shapes can alter or degrade the surface texture. Chemical methods in which the polymer formulation components are modified are also used to prepare rigid polymeric surfaces that withstand working and sanding. For example, acrylic solid surfaces are formulated with high concentrations of metal oxides that provide rigid surfaces, but the increased surface rigidity limits thermoformability and places limitations on draft angles, such that lower angles are prone to cracking and stress whitening at the bending position.

Textured surfaces may sometimes be manufactured by producing a rough plastic surface, followed by the addition of particulates or other materials to impart a roughened surface to the liquid or molten acrylic. However, for the formation of thinner surfaces and complex shapes, subsequent processing of the rough plastic surface by stretching or thermoforming results in a reduction or elimination of the features of the textured surface. The addition of some particulates also changes the stiffness and/or appearance of the surface and can render the material more prone to defects during shaping and bending.

While acrylic materials are initially lower in cost compared to traditional solid surface materials, post thermoforming treatment (especially of three-dimensionally shaped final products) is laboursome, oftentimes difficult, and increases the cost of the final article. Thus, it is desirable to have a material and process for an acrylic based material that forms a pleasing matte surface finish without the need for treatment after thermoforming

### SUMMARY OF THE DISCLOSURE

A novel thermoformable acrylic material comprising acrylic pre-polymerized syrup, comonomer, and a filler of a certain particle size creates a pleasing matte surface for articles such as bathtubs, shower pans, hot tubs, vanities, sinks, pool steps, and furniture when thermoformed and/or sufficiently stretched from a glossy sheet of cast acrylic. However, areas that are only minimally stretched, e.g., the flat deck areas of certain articles of manufacture, do not achieve the same reduction in gloss as the highly drawn portions of these same articles, e.g., side walls and bottom sections. Treatment of the novel thermoformable acrylic material prior to thermoforming (“pretreatment”) allows the novel acrylic material to retain/achieve a matte finish through the thermoforming process. Thus, the pretreatment of the novel acrylic material creates a substantially uniform matte surface on the final thermoformed acrylic article. With the below disclosed material and process, there is no longer a need for additional post thermoforming processes, otherwise required to at least treat areas of minimal stretching.

In accordance with some aspects of the present disclosure an acrylic article of manufacture is described. The acrylic article of manufacture includes articles designed for wet areas of a home including bath, kitchen, pools and the like, however it is to be appreciated that the present disclosure is not limited to wet areas and that the present disclosure is applicable to all articles requiring a substantially uniform matte finish. The acrylic article of manufacture is composed of a thermoformable composition about 35-95 wt % an acrylic pre-polymerized syrup, about 0-10 wt % of a comonomer, and about 5-65% of a filler by weight, wherein the filler has an average particle size (d50) in a range of 0.1 μm to 50 μm, and wherein the acrylic article is characterized by having a matte surface finish.

In accordance with another aspect of the present disclosure a method for producing a thermoformed article is described. The method includes preparing a thermoformable composition including about 35-95 wt % an acrylic pre-polymerized syrup, about 0-10 wt % of a comonomer; and about 5-65% of a filler by weight, wherein the filler has an average particle size (d50) in a range of 0.1 μm to 50 μm. The method also includes casting the thermoformable composition into a sheet. The method further includes pretreating the thermoformable composition sheet to provide a surface roughness and then thermoforming the pretreated cast sheet against a mold to produce a thermoformed article, wherein the thermoformed article has a matte finish.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a perspective view of an exemplary thermoformed article of manufacture having a stretched basin portion and a minimally stretched deck area in accordance with the present disclosure.

FIG. 2 is a block diagram of a method for producing a thermoformed acrylic article having a pleasing matte finish in accordance with the present disclosure.

### DETAILED DESCRIPTION

A more complete understanding of the materials, articles, components, processes and apparatuses disclosed herein can be obtained by reference to the accompanying drawings. These figures are merely schematic representations based on convenience and the ease of demonstrating the present disclosure and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The present disclosure relates to articles of manufacture from thermoformable compositions having increased thermoformability through control over the average particle size and the ratio of filler content to polymer matrix (“Thermoformable Compositions”), which can produce solid surfaces that bend to small radius angles not possible with conventional acrylic formulations. The thermoformability of these polymeric surfaces is also enhanced by adjusting the molecular structure of the material by controlling the density of the intra-and inter-molecular crosslinks between the polymer matrix and/or filler particles. The thermoformed articles of manufacture also have a desirable satin or matte finish (i.e., not glossy) after thermoforming without post-thermoforming processes.

Articles composed of the Thermoformable Compositions include polymer-forming compositions that contain one or more fillers having reduced particle size and concentration. The reduced concentration of filler increases the thermoformability of the solid surface, while maintaining the strength to withstand mechanical processing techniques. The thermoforming properties of the disclosed compositions is enhanced with respect to compositions having higher filler, resulting in a composition that can be folded on itself during thermoforming, including up to 0.5-inch radius in some embodiments, without loss of texture, crack formation, or stress-whitening, regardless of the color of the solid surface material. Thermoformable Compositions disclosed can be used to produce distinct, roughened, and “non-slip” surfaces for residential and commercial applications, including sheets and articles that range in thickness from 2.0 mm to 10 mm or greater.

The Thermoformable Compositions include a base of acrylic pre-polymerized syrup that can also include one or more comonomers or copolymers. The acrylic pre-polymerized syrup can be included at a percent by weight (wt %) of about 35-95 wt % of the Thermoformable Composition. In some embodiments, the acrylic pre-polymerized syrup can include a percent by weight of solids (wt %) of 5-40 wt %. The acrylic pre-polymerized syrup can include polymers and oligomers having a weight average molecular weight in a range between 10 k-450 k g/mol. Thermoformable Compositions can include a base of acrylate monomer in some cases, such as when the filler particle size is small (e.g., <2.0 μm) and/or for high filler content compositions (e.g., >20 wt %). For example, a Thermoformable Composition utilizing an acrylate monomer base can include a filler having a particle size of about 0.9 μm and at a percent by weight of about 50 wt %.

Thermoformable compositions can include one or more comonomers, copolymers, or additional pre-polymers at a percent by weight (wt %) in a range of about 0-10 wt %. Suitable comonomers (and polymers and pre-polymers formed therefrom) can include additional acrylate and methacrylate monomers, such as methyl acrylate, butyl acrylate, benzyl acrylate, methyl methacrylcate, and derivatives thereof. For thermoformable compositions incorporating copolymers or additional pre-polymers, the copolymers or additional pre-polymers can have a weight average molecular weight in a range between 10 k-450 k g/mol.

Thermoformable Compositions can exhibit enhanced thermoformability and surface texture by controlling at least two variables, individually or simultaneously: the properties of an added filler; and controlling the molecular structure of the polymer matrix.

In some embodiments, surface texture and thermoformability can be controlled by tuning the molecular structure of the polymer matrix by adjusting the molecular weight of the constituent polymer chains of the matrix and/or controlling the concentration of crosslinking and coupling agents to tune the density of the intra-and inter-strand crosslinks. By adjusting the molecular structure of the acrylic matrix, the overall rigidity of the material is decreased to enhance thermoformability, while also balancing with durability and chemical resistance of the solid surface.

Particle size of the filler can be used to control both surface texture and appearance in some embodiments. Larger particle sizes are often associated with increased surface roughness and rigidity, while smaller particle sizes can be associated with reduced glossiness and increased matte appearance. Thermoformable Compositions disclosed herein can include fillers having a mean particle size (d50) as determined by laser diffraction particle sizing analyzer in the range of about 0.1 μm to 50 μm, 1.0 μm to 25 μm, or 3.0 μm to 17 μm. As the d50 of the particles decreases, the hygroscopic nature and potential moisture content of the filler increases. Increased moisture content in the filler can lead increased moisture content in the final product (e.g., sheet or article) that leads to downstream defects, such as blistering. To reduce defects, Thermoformable Compositions can include fillers that are procured having, or are dried to include, a moisture content of less than about 1.0 wt %, 0.5 wt %, or 0.3 wt %.

In some embodiments, surface texture and thermoformability can be controlled by tuning the molecular structure of the polymer matrix by adjusting the molecular weight of the constituent polymer chains of the matrix and/or controlling the concentration of crosslinking and coupling agents to tune the density of the intra-and inter-strand crosslinks. By adjusting the molecular structure of the acrylic matrix, the overall rigidity of the material is decreased to enhance thermoformability, while also balancing with durability and chemical resistance of the solid surface.

For crosslinked solid surfaces produced after processing Thermoformable Compositions, the molecular weight of the polymer matrix and degree of crosslinking is characterized according to the thermoformability parameter (Q value) that is used to describe the swelling ratio of the cross-linked acrylic. The Q value is described according to Eq. 1:

$$Q value = ( Wt + We / Ds ) + 0.1 + Wo / Do \qquad ( 1 )$$

where the Q value is the swelling ratio, Wt is the weight of the swollen polymer at equilibrium, We is the weight of the extracted materials, Ds is the density fo the solvent (methylene chloride=1.336), Wo is the weight of the original sample, and Do is the density of the polymer (acrylic=1.2). In general, a decreasing Q value indicates increased crosslink density. Thermoformable Compositions disclosed herein can form articles having a Q value ranging from about 5.0 to about 25 following thermoforming in some embodiments.

Thermoformable Compositions can include one or more coupling agents that increase dispersion of the filler and the polymer matrix. In some embodiments, Thermoformable Compositions can include one or more coupling agents at a percent by weight (wt %) within a range of about 0.05 wt % to 1.0 wt %, 0.05 wt % to 0.75 wt %, or 0.10 wt % to 0.50 wt %.

Suitable coupling agents can include 3-methacryloxypropyltrimethoxysilane, 2-hydroxyethylmethacrylate, 8-methacryloxyoctyltrimethoxysilane, and reactive polymeric coupling agents such as BYK-C 8002 and polypropylene glycol phosphate ester Sipomer PAM200.

Thermoformable Compositions can also include crosslinking agents having two or more vinyl groups capable of forming intra-and inter-molecular crosslinks within the acrylic matrix during processing and/or thermoforming. Suitable crosslinking agents include ethylene glycol dimethacrylate, polyethylene glycol dimethacrylates such as PEG200 and PEG600 dimethacrylate, trimethylolpropane-tris-methacrylate (TRIM), Triallyl isocyanurate (TAlC), triallyl cyanurate (TAC), and the like. In some embodiments, Thermoformable Compositions can include one or more crosslinking agents at a percent by weight (wt %) within a range of about 0.05 wt % to 1.5 wt %, 0.05 wt % to 1.5 wt %, or 0.05 wt % to 1.5 wt %.

Thermoformable Compositions also include a number of functional additives to initiate and control various properties of the thermoforming reaction including initiators, chain transfer agents, wetting/dispersing agents, anti-flocculating agents, pigments, release agents, air release agents, suspension agents, and the like.

Exemplary formulation guidelines for the production of the Thermoformable Compositions herein are provided in Table 1.

TABLE 1

| Class | Compound | Amount | |
|---|---|---|---|
| Pre-Polymer | Acrylic pre-polymerized | 35-95 | wt % |
| | syrup at 20% solid | | |
| Copolymer or comonomer | MMA—methyl methacrylate | 0-10 | wt % |
| Wetting/dispersing agent | BYK1142 | 0.0-1 | wt % |
| Filler | aluminum trihydrate (ATH) | 5-65 | wt % |
| Coupling agent | 3-methacryloxypropyl | 0.0-1.0 | wt % |
| | trimethoxysilane | | |
| Anti-flocculating agent | Triisooctyl phosphate | 0.1-0.8 | wt % |
| Pigment | — | 0.5-4.0 | wt % |
| Chain transfer agent | N-dodecyl mercaptan | 0.2-2.0 | wt % |
| Release agent | Zelec UN-Phosphate ester | 0.05-0.1 | wt % |
| Crosslinking agent | Ethylene glycol dimethacrylate | 0.1-1.0 | wt % |
| Initiator 1* | t-butyl peroxypivalate | 0.01-0.4 | wt % |
| Initiator 2* | t-butyl peroxyneodecanoate | 0.0-0.4 | wt % |
| Initiator 3* | t-amyl peroxy-2-ethyl-hexanoate | 0.01-0.2 | wt % |
| Suspension Agent | Silica (fumed and/or precipitated) | 0.1-5.0 | wt % |
| Air Release Agent | BYK 555 | 0.0-1.0 | wt % |

Thermoformable Compositions can be processed into textured solid surfaces by any suitable continuous or batch technique. In some embodiments, textured solid surfaces can be prepared by combining the components in Table 1 and degassing the resulting Thermoformable Composition under vacuum. The de-gassed “syrup” is then either poured into a cell or poured onto a continuous casting machine. In some embodiments, the syrup is heated to about 185° F. for a suitable period of time, such as about 20 minutes. The syrup is then transferred to a cell and heated in a forced air oven at about 240° F. for about 12 minutes. If cast against a highly polished surface, once cool, the final acrylic article can have a high gloss finish. However, if this sheet is thermoformed against a mold, the included filler can introduce surface texture as the final acrylic article is stretched and thinned.

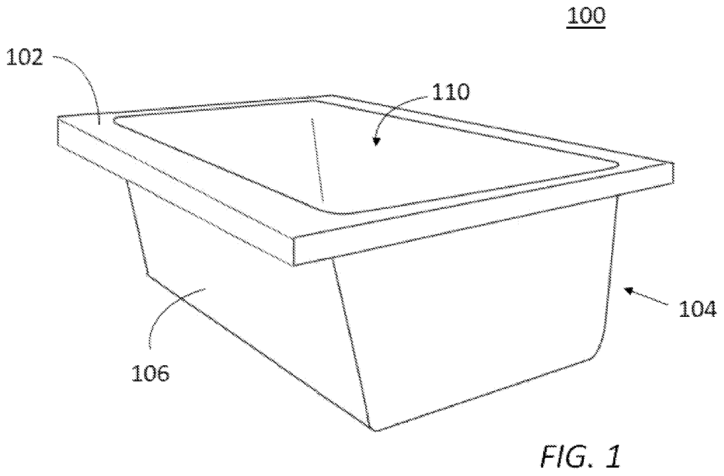

FIG. 1 illustrates an exemplary article of manufacture in accordance with the present disclosure. It is to be appreciated that while the thermoformed article 100 of substantially rectangular shape is shown, the shape of the article 100 is not limiting. That is, any shape of article that may be accomplished via thermoforming processes is contemplated herein without delineating from the scope of this disclosure. Furthermore, it is to be appreciated that the disclosure is not limited to bathtubs, but is applicable to thermoformed acrylic articles that have portions that experience different amounts of stretching during forming. For example and without limitation, the present disclosure has applicability to shower basins, sinks, hot tubs, swim spas, vanities, formed shower walls, furniture, modular bathrooms, table tops, column wraps, décor, retail displays, seating, pool steps, pools, and the like.

The exemplary thermoformed article 100 of FIG. 1 includes a highly stretched portion and a portion that experiences minimal stretching during the thermoforming process. The thermoformed article 100, as illustrated, includes a deck 102 which at least partially surrounds a highly stretched basin portion 104 composed of at least one sidewall 106. The at least one sidewall 106 defines a hollow inner bowl 110. The inner hollow bowl 110 may be configured to retain a quantity of fluid, like a bathtub, sink, and shower pan. In some embodiments, the deck 102 is a substantially flat area that projects over the sidewalls 106 away from the inner bowl 110 in a flange-like manner. In some embodiments, a matte finish occurs in areas stretched beyond 50%. For example, the deck 102 may experience about 10-15% stretching while the basin portion may experience greater than 50% stretching resulting in a deck 102 a gloss finish and a basin portion 104 with a matte finish.

Thermoformed articles 100 are manufactured by thermoforming processes wherein, in some embodiments, a substantially flat sheet of thermoformable acrylic material (typically about 2.0 mm to about 5.0 mm in thickness) is held by its edges, raised to a thermoforming temperature, and then stretched in relation to a shaped mold. Typically, the basin portion 104 experiences more stretching than the deck 102 as the sheet material is typical held approximate the deck 102 and the more central basin portion 104 is made to stretch and conform to the three dimensional mold. Due to the lower amount of stretch, the deck 102 generally exhibits aesthetics that are different from the more stretched basin portion 104.

The thermoformable articles are composed of a Thermoformable Composition including about 35-95 wt % an acrylic pre-polymerized syrup; about 0.0-10 wt % of a comonomer; and about 5.0-65 wt % of a filler (The filler may have an average particle size (d50) in a range of about 0.1 μm to about 50 μm. In some exemplary embodiments, the Thermoformable Composition is prepared by combining the components in Table 1. During forming the included filler can introduce surface texture as the final acrylic article is stretched and thinned. Areas of the article that experience higher stretching may show more surface texture than those areas with lower stretching. Thus, there is generally a requirement that current thermoformed articles 100 includes post-thermoforming processes so that the matte aesthetic of the article 100 is substantially uniform (e.g., at least between the highly stretched basin portion 104 and minimally stretched deck 102.).

A substantially uniform textured/matte aesthetic may be achieved without post-thermoforming treatment by pre-treating a sheet of Thermoformable Composition prior to thermoforming, described in greater detail below. Generally, a cast sheet of Thermoformable Composition has a gloss aesthetic. The gloss of the material may be measured by a glossmeter (generally at 60 degrees). The gloss of a sheet Thermoformable Composition may have a gloss greater than about 70 units. In some embodiments, the gloss of a sheet of Thermoformable Composition may have a gloss of about 95 units. The glossy sheet of Thermoformable Material is pre-treated such that the gloss is reduced to less than 10 units. In further embodiments the Thermoformable Material is pre-treated such that the gloss is reduced about 3-4 units.

The pretreated Thermoformable Material yields a thermoformed article 100 having a substantially uniform matte finish despite the deck 102 being stretched less than the basin portion 104.

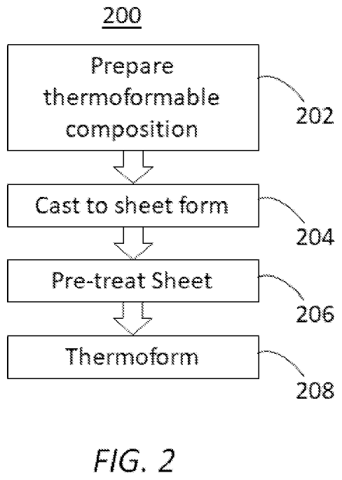

FIG. 2 is a block diagram of an exemplary method for manufacturing a thermoformed article 100 having a deck 102 and basin portion 104 characterized by a matte finished is provided. The method 200 includes, at block 202 preparing a Thermoformable Composition. The Thermoformable Composition is composed of about 35-95 wt % an acrylic pre-polymerized syrup; about 0-10 wt % of a comonomer; and about 5-65 wt % of a filler. The filler may have an average particle size (d50) in a range of 0.1 μm to 50 μm. In some exemplary embodiments, the Thermoformable Composition is prepared by combining the components in Table 1 and may be best understood with reference thereto.

At block 204, a syrup of the Thermoformable Composition may be degassed and processed by a casting machine, including but not limited to a continuous casting machine. In some embodiments, the casting of sheet produces a sheet of material having a gloss greater than about 70 units.

At block 206 the sheet of the thermoformable composition is pre-treated. Treatment at 206 reduces the gloss of the sheet from greater than about 70 units to less than about 10 units. In some embodiments, the treatment at 206 reduces the gloss from about 95 units to about 3-4 units. The pre-treatment may include mechanical enhancement of at least one surface of the cast sheet that reduces the gloss. Mechanical enhancement may include but is not limited to sanding, media blasting, and embossing. For example and without limitation the pre-treatment includes sanding with a grit of about 320.

In some embodiments, at least one entire surface of a sheet of Thermoformable Composition is mechanically enhanced, reducing the gloss of the entire surface to less than about 10 units. In some other embodiments, the mechanical enhancement of the sheet of Thermoformable Composition is selective. That is, only selected areas of the sheet of Thermoformable Composition are treated at block 206. For example and without limitation, the selected areas of mechanical enhancement correspond to the area of the sheet that becomes the deck 102 of the exemplary thermoformed article 100. That is, the treatment at block 206 is applied to areas of a sheet of Thermoformable Composition corresponding to portions of the thermoformed article that experience minimal stretching.

At block 208, the pre-treated sheet of Thermoformable Composition is thermoformed to a final article shape. That is, the sheet of Thermoformable Composition is heated to a pliable thermoforming temperature and formed to a specific shape in a mold. In some embodiments, the thermoforming temperature is the glass transition temperature of the Thermoformable Composition. In other embodiments, the thermoforming temperature is a temperature greater than the glass transition temperature of the Thermoformable Compositions. In some further embodiments, the thermoforming temperature is in a range from about 360° F. to about 380° F. In yet further embodiments, the thermoforming temperature is about 360° F.

It is to be appreciated that various different conventional thermoforming process may be used to create thermoformed articles having a pleasing matte finish. In some embodiments, the thermoforming process is vacuum forming. In other embodiments, the thermoforming process is pressure forming. In yet still other embodiments, the thermoforming process is a combination of vacuum and pressure forming. In some embodiments, the thermoforming process includes a demolding process. In some embodiments, demolding includes raising the temperate of the mold and or thermoformed article. The demolding temperature may be in the range of about 150 to 170° F.

Thermoformable Compositions disclosed herein can be processed for form textured surfaces for a number of commercial and residential applications including surfaces for “wet” areas such as sinks, bathtubs, shower pans, and the like, in addition to construction surfaces, and various architectural components.

Advantages of the thermoformed articles composed of Thermoformable Compositions include a significant reduction in weight of the final product compared to solid surface alternatives. For example, a solid surface bathtub may weigh about 300+ pounds while an identical size bathtub thermoformed as described herein may have a weight of about 100 pounds. That is, the articles of manufacture thermoformed from the novel Thermoformable Compositions may have a weight reduction of about ¼ to about ⅓ of the weight of an identical solid surface article.

Other advantages relate to repair of the thermoformed article. That is, repair of the disclosed articles is fairly easy. Areas the article that become scuffed or scratched during use may repaired by mechanically treating the scuffed/scratched surface, e.g., with 320 grit sand paper. Since the material composition is the uniform throughout the thickness of the article the repaired area may blend in with the remaining matte surface of the article.

The following examples are provided to illustrate the articles, devices and processes of the present disclosure. The examples are merely illustrative and are not necessarily intended to limit the disclosure to the materials, conditions, or process parameters set forth therein.

### EXAMPLE 1

A first sheet of thermoformable composition as shown in Table 1 was cast. The sheet was a 12 inch by 12 inch sheet of material with a thickness of 0.125 inches. The original gloss reading on the first flat sample was 90 gloss units measured at 60 degrees. The sheet was thermoformed to a shape similar to that illustrated in FIG. 1, having a basin portion and a deck portion. The 12 inch×12 inch samples was heated at 380° F. for a total heating time of 150 sec. The drawn depth of the 8.5 inches×8.5 inches square basin was 2.5 inches with 1 inch wide deck. The non-treated thermoformed part exhibited a gloss reading of about 10.4 gloss units in the highly stretched basin portion and a gloss reading of about 30 gloss units on the deck portion.

### EXAMPLE 2

A second sheet of thermoformable composition was cast similar to that of the sheet of Example 1. The sheet was pre-treated with 320 grit sand paper over the entire surface of the square sheet. The treated flat sheet exhibited a gloss reading of less than 4, typically 2.6 to 3. The pre-treated sheet was thermoformed to the identical shape described with respect to Example 1. The pre-treated thermoformed article exhibited a gloss reading of about 4.7 units in the highly stretched basin portion and a gloss reading of about 3.2 units on the deck portion.

### EXAMPLE 3

A third sheet of thermoformable composition was cast. The sheet was a 12 inch by 12-inch sheet of material similar to the sheets of Examples 1 and 2. The sheet was selectively pre-treated with 320 grit sand paper. The pretreatment was applied around the perimeter of the 12-inch square shape from the edge to about 3.5 inches toward the center. The treated areas of the sheet exhibited a gloss reading of less than 4. The selectively pre-treated sheet was thermoformed to the identical shape described with respect to Example 1. The selectively pre-treated thermoformed article exhibited a gloss reading of about 9.7 units in the highly stretched basin portion and a gloss reading of about 3.2 units on the deck portion (corresponding to the pre-treated portion).

The examples show that a reduction is gloss is achieved when the material is sufficiently stretched. However, the minimally stretched deck portion had a gloss reading 3-4 times higher than the higher stretched basin. Thus, the difference in gloss about 40 units vs. about 10 units is not a substantially uniform in a visual or aesthetic sense. According to architectural standards high gloss is more than 85 units, traditional gloss is 70-85 units, semi-gloss is 35-70 units, satin finish is about 20-35 units, eggshell is about 10-25 units, and traditional matte is about 5 units. Mechanically pretreating the surface. Thus, a non-pretreated article would exhibit both a matte basin and a semi-gloss like deck. Pretreating the surface and then thermoforming provides a both a deck and basin area exhibiting less than 5 units of gloss at 60 degrees, thus the final aesthetic is substantially uniform.

### ADDITIONAL EMBODIMENTS

The present disclosure is also directed to the following exemplary embodiments:

Embodiment 1: A thermoformable acrylic article, comprising: a basin portion, a deck at least partially surrounding the basin portion, wherein the thermoformable article is made of a thermoformable composition comprising: a) about 35-95 wt % an acrylic pre-polymerized syrup; b) about 0-10 wt % of a comonomer; and c) about 5-65 wt % of a filler, wherein the filler has an average particle size (d50) in a range of 0.1 μm to 50 μm, and, wherein the surface of the thermoformable article has a matte finish.

Embodiment 2: The article of embodiment 1, wherein the thermoformable article has a gloss reading of less than 15 units.

Embodiment 3: The article of embodiment of claim 1, wherein the thermoformable article has a gloss reading of less than 10 units, preferably less than 5 units.

Embodiment 4: The article of any of embodiments of 1-3, wherein the basin portion comprises at least one sidewall.

Embodiment 5: The article of any of embodiments of 1-4, wherein the article is one of a bathtub, sink, shower basin, and hot tub.

Embodiment 6: The article of any of embodiments 1-5, wherein the filler comprises less than about 1 wt % of moisture.

Embodiment 7: The article of any of embodiments 1-6, wherein the ratio of filler to acrylic pre-polymerized syrup is in a range of 0.05 to 1.9.

Embodiment 8: The article of any of embodiments 1-7, wherein the filler is one or more selected from a group consisting of aluminum trihydrate, aluminum monohydrate, magnesium hydroxide, calcium carbonate, magnesium silicate, talc, silica, calcium carbonate, calcium metasilicate, Wollastonite, Dolomite, Perlite, hollow glass spheres, and kaolin.

Embodiment 9: The article of any of embodiments 1-8, further comprising one or more selected from a group consisting of wetting/dispersing agent, anti-flocculating agent, pigment, release agent, air release agent, suspension agent, and initiator.

Embodiment 10: The article of any of embodiments 1-9, wherein the acrylic pre-polymerized syrup has a percent by weight of solids (wt %) ranging from 5 wt % to 40 wt %.

Embodiment 11: The article of any of embodiments 1-10, wherein the comonomer is butyl acrylate.

Embodiment 12: The article of any of embodiments 1-11, wherein the article further comprises: about 0.0-1.0 wt % of a coupling agent; and about 0.1-1.0 wt % of a crosslinking agent.

Embodiment 13: The article of any of embodiments 1-12, wherein the thermoformable composition forms an article having a Q value ranging from 5 to 25 following thermoforming.

Embodiment 14: A method comprising: i.) preparing a thermoformable composition comprising: a) about 35-95 wt % an acrylic pre-polymerized syrup; b) about 0-10 wt % of a comonomer; and c) about 5-65 wt % of a filler, wherein the filler has an average particle size (d50) in a range of 0.1 μm to 50 μm; ii) casting the thermoformable composition into a sheet; iii) mechanically treating the cast sheet; iii) thermoforming the mechanically treated cast sheet against a mold to produce a thermoformed article.

Embodiment 15: The method of embodiment 14, wherein the filler comprises less than about 1 wt % of moisture.

Embodiment 16: The method of embodiments 14 and/or 15, wherein the ratio of filler to acrylic pre-polymerized syrup is in a range of 0.05 to 1.9.

Embodiment 17: The method of any of the embodiments 14-16, wherein the acrylic pre-polymerized syrup has a percent by weight of solids (wt %) ranging from 5 wt % to 40 wt %.

Embodiment 18: The method of any of the embodiments 13-17, wherein the thermoformed article has a Q value ranging from 5 to 25 following thermoforming.

Embodiment 19: The method of any of the embodiments 13-18, wherein mechanically treating the cast sheet comprises sanding, media blasting and/or embossing.

Embodiment 20: The method of any of the embodiments 13-18, wherein mechanically treating the cast sheet comprises treating at least one entire surface of the cast sheet.

Embodiment 21: The method of any of the embodiments 13-18, wherein mechanically treating the cast sheet comprises selectively treating a portion of the cast sheet.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising.” it is understood that we also contemplate the same composition or group of elements with transitional phrases “consisting essentially of,” “consisting of,” “selected from the group of consisting of,” or “is” preceding the recitation of the composition, element, or elements and vice versa.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b.” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

1. A thermoformable acrylic article, comprising:
a basin portion
a deck at least partially surrounding the basin portion,
wherein the thermoformable article is made of a thermoformable composition comprising:
a) about 35-95 wt % an acrylic pre-polymerized syrup;
b) about 0-10 wt % of a comonomer; and
c) about 5-65 wt % of a filler, wherein the filler has an average particle size (d50) in a range of 0.1 μm to 50 μm, and,
wherein the surface of the thermoformable article has a matte finish.

2. The article of claim 1, wherein the thermoformable article has a gloss reading of less than 15 units.

3. The article of claim 1, wherein the thermoformable article has a gloss reading of less than 10 units, preferably less than 5 units.

4. The article of claim 1, wherein the basin portion comprises at least one sidewall.

5. The article of claim 1, wherein the article is one of a bathtub, sink, shower basin, and hot tub.

6. The article of claim 1, wherein the filler comprises less than about 1 wt % of moisture.

7. The article of claim 1, wherein the ratio of filler to acrylic pre-polymerized syrup is in a range of 0.05 to 1.9.

8. The article 1, wherein the filler is one or more selected from a group consisting of aluminum trihydrate, aluminum monohydrate, magnesium hydroxide, calcium carbonate, magnesium silicate, talc, silica, calcium carbonate, calcium metasilicate, Wollastonite, Dolomite, Perlite, hollow glass spheres, and kaolin.

9. The article of claim 1, further comprising one or more selected from a group consisting of wetting/dispersing agent, anti-flocculating agent, pigment, release agent, air release agent, suspension agent, and initiator.

10. The article of claim 1, wherein the acrylic pre-polymerized syrup has a percent by weight of solids (wt %) ranging from 5 wt % to 40 wt %.

11. The article of claim 1, wherein the comonomer is butyl acrylate.

12. The article of claim 1, wherein the article further comprises:
about 0.0-1.0 wt % of a coupling agent; and
about 0.1-1.0 wt % of a crosslinking agent.

13. The thermoformable article of claim 1, wherein the thermoformable composition forms an article having a Q value ranging from 5 to 25 following thermoforming.

14. A method for producing a thermoformed article by the steps of:
i.) preparing a thermoformable composition comprising:
a) about 35-95 wt % an acrylic pre-polymerized syrup;
b) about 0-10 wt % of a comonomer; and
c) about 5-65 wt % of a filler, wherein the filler has an average particle size (d50) in a range of 0.1 μm to 50 μm;
ii) casting the thermoformable composition into a sheet;
iii) mechanically treating the cast sheet;
iii) thermoforming the mechanically treated cast sheet against a mold to produce a thermoformed article.

15. The method of claim 10, wherein the filler comprises less than about 1 wt % of moisture.

16. The method of claim 10, wherein the ratio of filler to acrylic pre-polymerized syrup is in a range of 0.05 to 1.9.

17. The method of claim 10, wherein the acrylic pre-polymerized syrup has a percent by weight of solids (wt %) ranging from 5 wt % to 40 wt %.

18. The method of claim 10, wherein the thermoformed article has a Q value ranging from 5 to 25 following thermoforming.

19. The method of claim 10, wherein mechanically treating the cast sheet comprises sanding, media blasting and/or embossing.

20. The method of claim 10, wherein mechanically treating the cast sheet comprises treating at least one entire surface of the cast sheet.

21. The method of claim 10, wherein mechanically treating the cast sheet comprises selectively treating a portion of the cast sheet.
